(19) United States
(12) Patent Application Publication
(10) Pub. No.: US 2025/0363723 A1
(43) Pub. Date: Nov. 27, 2025

(54) METHOD AND APPARATUS FOR DYNAMIC GAUSSIAN SPLATTING

(71) Applicants: Electronics and Telecommunications Research Institute, Daejeon (KR); KOREA ADVANCED INSTITUTE OF SCIENCE AND TECHNOLOGY, Daejeon (KR)

(72) Inventors: Joo Young LEE, Daejeon (KR); Mun Churl KIM, Daejeon (KR); Jong Min PARK, Daejeon (KR); Jung Won KANG, Daejeon (KR); Se Yoon JEONG, Daejeon (KR)

(73) Assignees: Electronics and Telecommunications Research Institute, Daejeon (KR); KOREA ADVANCED INSTITUTE OF SCIENCE AND TECHNOLOGY, Daejeon (KR)

(21) Appl. No.: 19/216,921

(22) Filed: May 23, 2025

(30) Foreign Application Priority Data
May 23, 2024 (KR) 10-2024-0067401
Nov. 29, 2024 (KR) 10-2024-0175446

(51) Int. Cl. G06T 15/08

(52) U.S. Cl. CPC G06T 15/08; G06T 2200/04

(57) ABSTRACT

A method and apparatus generate a 2-dimensional (2D) image. A method for generating a 2-dimensional (2D) image includes obtaining a time index and a view. The method further includes obtaining first coding indices and a first codebook for canonical 3D Gaussians, wherein the canonical 3D Gaussians are 3D Gaussians corresponding to a reference time index, and represent a 3D space corresponding to the reference time index. The method also includes obtaining second encoding indices and a second codebook for a parameter offset, wherein the parameter offset indicates a difference between the canonical 3D Gaussians and 3D Gaussians for the time index. The method further includes reconstructing the canonical 3D Gaussians based on the first coding indices and the first codebook. The method also includes reconstructing parameter offsets of the 3D Gaussians for the time index based on the second coding indices and the second codebook. The method further includes adding the reconstructed canonical 3D Gaussians and the reconstructed parameter offset to reconstruct the 3D Gaussians for the time index. The method also includes generating a second image for the view based on the reconstructed 3D Gaussians.

### CROSS-REFERENCE TO RELATED APPLICATION

This application claims the benefit of and priority to Korean Patent Applications No. 10-2024-0067401, filed in the Korean Intellectual Property Office on May 23, 2024, and No. 10-2024-0175446, filed in the Korean Intellectual Property Office on Nov. 29, 2024, the entire disclosures of which is incorporated herein in its entirety by reference.

### TECHNICAL FIELD

The present disclosure relates to a method and an apparatus for dynamic Gaussian splatting.

### BACKGROUND

The statements in this section merely provide background information related to the present disclosure and do not constitute prior art.

3D Gaussian splatting (GS) is a view synthesis technique for training a specific 3D space to generate a 2D image corresponding to a view desired by a user. The 3D Gaussian splatting (GS) has a greatly improved operation efficiency compared to an existing neural radiance field (NeRF) that learns a view synthesis by utilizing ray casting and multi-layer perceptron (MLP) based neural networks. The 3D GS is an explicit representation scheme that explicitly constructs a 3D scene based on a large number of anisotropic 3D Gaussians. The 3D GS may be trained based on a 3D point cloud obtained from a plurality of 2D images using a structure from a motion (SfM) algorithm. Training parameters of the 3D GS include location x, size s, rotation r, color c, and opacity o of the 3D Gaussian. The 3D GS generates a 2D image by utilizing the trained 3D Gaussian and a camera pose to project the 3D scene into a 2D plane of a desired view.

Since the 3D GS technology operates based on a static scene, a desired 3D rendering performance cannot be expected if the 3D GS technology is simply applied to a dynamic scene in which there is object movement over time. By utilizing a dynamic 3D GS technique that reflects the object movement in the 3D GS technology, an inference speed related to 3D rendering of the dynamic scene can be improved. However, since training and inference require tens of giga-bytes (GB) of graphic processing unit (GPU) memory, the dynamic 3D GS technique cannot be smoothly utilized in a device environment with a limited memory, such as a portable terminal, a headset, and the like. Accordingly, a dynamic GS technique that can reduce the memory and time complexity required in training and inference should be considered.

### SUMMARY

An objective of the disclosed embodiments is to provide a method and an apparatus for dynamic Gaussian splatting which code canonical 3D Gaussians and parameters representing time-indexed parameters by performing grouping for the canonical 3D Gaussians and parameter offsets based on a codebook, and infer a 2D image corresponding to a desired time and a desired view based on the reconstructed canonical 3D Gaussians and parameter offsets.

The objectives to be achieved by the present disclosure are not limited to the objectives described above, and other objectives not explicitly mentioned should be apparent to those of ordinary skill in the art from the following description.

According to an aspect of the present disclosure, there is provided a method for generating a 2-dimensional (2D) image, which is performed by a dynamic Gaussian splatting apparatus. The method comprises obtaining a time index and a view. The method further comprises obtaining first coding indices and a first codebook for canonical 3D Gaussians, wherein the canonical 3D Gaussians are 3D Gaussians corresponding to a reference time index, and represent a 3D space corresponding to the reference time index. The method also comprises obtaining second encoding indices and a second codebook for a parameter offset, wherein the parameter offset indicates a difference between the canonical 3D Gaussians and 3D Gaussians for the time index. The method further comprises reconstructing the canonical 3D Gaussians based on the first coding indices and the first codebook. The method also comprises reconstructing parameter offsets of the 3D Gaussians for the time index based on the second coding indices and the second codebook. The method further comprises adding the reconstructed canonical 3D Gaussians and the reconstructed parameter offset to reconstruct the 3D Gaussians for the time index. The method also comprises generating a second image for the view based on the reconstructed 3D Gaussians.

According to another aspect of the present disclosure, there is provided a dynamic Gaussian splatting apparatus. The apparatus comprises a storage configured to store first coding indices and a first codebook for canonical 3D Gaussians, and second coding indices and a second codebook for a parameter offset, wherein the canonical 3D Gaussians are 3D Gaussians corresponding to a reference time index, and represent a 3D space corresponding to the reference time index, and the parameter offset indicates a difference between the canonical 3D Gaussians and 3D Gaussians for the time index. The apparatus further comprises a Gaussian reconstruction unit configured to reconstruct the canonical 3D Gaussians based on the first coding indices and the first codebook. The apparatus also comprises an offset reconstruction unit configured to obtain a time index, and reconstruct parameter offsets of the 3D Gaussians for the time index based on the second coding indices and the second codebook. The apparatus further comprises an adder configured to reconstruct the 3D Gaussians for the time index by adding the reconstructed canonical 3D Gaussians and the reconstructed parameter offset. The apparatus also comprises a 2D image generation unit configured to obtain a view, and generate a 2D image for the view based on the reconstructed 3D Gaussians.

According to still another aspect of the present disclosure, there is provided a method for compressing a dynamic 3-dimensional (3D) space. The method comprises obtaining time indices and canonical 3D Gaussians, wherein the canonical 3D Gaussians are 3D Gaussians corresponding to a reference time index, and represent a 3D space corresponding to the reference time index. The method further comprises generating a first codebook by grouping parameters of the canonical 3D Gaussians. The method also comprises generating first coding indices of the canonical 3D Gaussians based on a nearest code in the first codebook. The method further comprises generating a parameter offset for each time index by using a deep learning-based prediction network based on each time index and locations of the canonical 3D Gaussians, wherein the parameter offset indicates a difference between the canonical 3D Gaussians and 3D Gaussians for each time index. The method also comprises generating a second codebook by grouping parameter offsets for time indices. The method further comprises generating second coding indices of parameter offsets for the 3D Gaussians of the time indices based on a nearest code in the second codebook. The method also comprises storing the first codebook, the first coding indices, the second codebook, and the second coding indices. The method further comprises inferring a 2D image based on the first codebook, the first coding indices, the second codebook, and the second coding indices.

The disclosed embodiments of the present disclosure minimize performance degradation during training and inference, and dramatically reduce required GPU memory by providing a method and an apparatus for dynamic Gaussian splatting (GS) that encode canonical 3D Gaussians and parameters representing time-indexed offsets by performing grouping on the canonical 3D Gaussians and parameter offsets based on a codebook.

The disclosed embodiments of the present disclosure reduce complexity of 4D spatiotemporal rendering considering movement of an object over time by providing a method and an apparatus for dynamic Gaussian splatting (GS) that infer a 2D image corresponding to a desired time and a desired view based on the reconstructed canonical 3D Gaussians and parameter offsets.

The technical effects of the present disclosure are not limited to the above-mentioned effects. Other effects not mentioned should be clearly understood by those of ordinary skill in the art from the description below.

### BRIEF DESCRIPTION OF THE DRAWINGS

FIG. 1 is an exemplary diagram illustrating a Gaussian splatting apparatus according to an embodiment of the present disclosure.

FIG. 2 is an exemplary diagram illustrating a dynamic Gaussian splatting apparatus according to an embodiment of the present disclosure.

FIG. 3 is an exemplary diagram compression of a canonical 3D Gaussian according to an embodiment of the present disclosure.

FIG. 4 is an exemplary diagram illustrating a process of generating parameter offsets according to an embodiment of the present disclosure.

FIG. 5 is an exemplary diagram illustrating a compression process of the parameter offsets according to an embodiment of the present disclosure.

FIG. 6 is a flowchart illustrating a method for generating a 2D image by a dynamic Gaussian splatting apparatus according to an embodiment of the present disclosure.

FIG. 7 is a flowchart illustrating a method for compressing a dynamic 3D space by the dynamic Gaussian splatting apparatus according to an embodiment of the present disclosure.

### DETAILED DESCRIPTION

Hereinafter, some exemplary embodiments of the present disclosure will be described in detail with reference to the accompanying drawings. In the following description, like reference numerals preferably designate like elements, although the elements are shown in different drawings. Further, in the following description of some embodiments, a detailed description of known functions and configurations incorporated therein will be omitted for the purpose of clarity and for brevity.

Additionally, various terms such as first, second, A, B, (a), (b), etc., are used solely to differentiate one component from the other but not to imply or suggest the substances, order, or sequence of the components. Throughout this specification, when a part ‘includes’ or ‘comprises’ a component, the part is meant to further include other components, not to exclude thereof unless specifically stated to the contrary. The terms such as ‘unit’, ‘module’, and the like refer to one or more units for processing at least one function or operation, which may be implemented by hardware, software, or a combination thereof.

Each element of the apparatus or method in accordance with the present invention may be implemented in hardware or software, or a combination of hardware and software. The functions of the respective elements may be implemented in software, and a microprocessor may be implemented to execute the software functions corresponding to the respective elements.

The following detailed description, together with the accompanying drawings, is intended to describe exemplary embodiments of the present invention, and is not intended to represent the only embodiments in which the present invention may be practiced.

The embodiment relates to a method and an apparatus for dynamic Gaussian splatting. More particularly, the embodiment provides a method and an apparatus for dynamic Gaussian splatting (GS) which code canonical 3D Gaussians and parameters representing time-indexed offsets by performing grouping for the canonical 3D Gaussians and parameter offsets based on a codebook. The method and the apparatus for dynamic GS infer a 2D image corresponding to a desired time and a desired view based on the reconstructed canonical 3D Gaussians and parameter offsets.

Hereinafter, an operation of a GS apparatus is described prior to describing the dynamic GS apparatus.

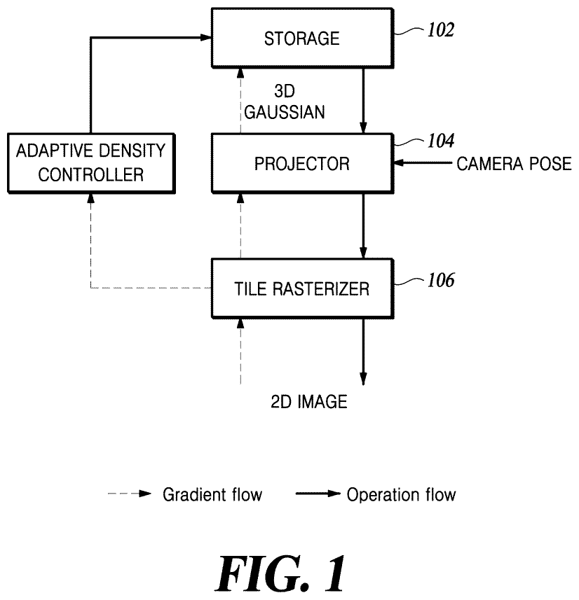

FIG. 1 is an exemplary diagram illustrating a Gaussian splatting apparatus according to an embodiment of the present disclosure.

A static 3D Gaussian splatting (GS) apparatus (hereinafter, used interchangeably with a ‘3D GS apparatus’ or ‘GS apparatus’) explicitly represents a 3D scene based on a large number of anisotropic 3D Gaussians. As illustrated in FIG. 1, the GS apparatus includes a storage 102, a projector 104, and a tile rasterizer 106. In order to explicitly represent the 3D scene, the GS apparatus may further include a density controller 108 and a training unit (not illustrated).

Hereinafter, a component including the projector 104 and the tile rasterizer 106 is referred to as a 2D image generation unit (not illustrated).

The storage 102 stores 3D Gaussians. The 3D Gaussians may be initialized by a 3D point cloud obtained from a plurality of 2D images using a structure from motion (SfM) algorithm. Parameters constituting the 3D Gaussian include location x, size s, rotation r, color c, and opacity o of the 3D Gaussian. In inference, trained 3D Gaussians are utilized.

The GS apparatus generates a 2D image by utilizing the trained 3D Gaussian and camera pose to project a 3D scene to a 2D plane at a desired view.

The projector 104 obtains the camera pose and the 3D Gaussians as inputs, and projects the 3D Gaussians onto a 2D image plane according to the camera pose to construct 2D Gaussians. In the inference, a camera pose corresponding to any view may be used as an input.

The tile rasterizer 106 generates a 2D image corresponding to the camera pose based on differentiable tile rasterization. The tile rasterizer 106 may generate the 2D image based on the projected 2D Gaussians. Compared to the existing neural radiance field (NeRF), the tile rasterizer 106 may quickly render the 2D image. A method in which the tile rasterizer 106 renders the 2D image is not included in the scope of the present disclosure, and thus, a detailed description thereof is omitted.

In FIG. 1, an operation flow represents a path through which the 2D image is rendered by the GS apparatus, for example, a path through which the 2D image at any view is inferred based on the trained 3D Gaussian. For example, any view may be a view that is not used in training for generation of the 2D image.

Hereinafter, a process in which the training unit trains the 3D Gaussian to learn a method for explicitly representing a 3D space will be described. In FIG. 1, a gradient flow represents a path along which a gradient derived from a loss function propagates for training.

The training unit infers the 2D image based on current 3D Gaussians and the camera pose utilized for initialization of the 3D Gaussians. In this process, projection and (differentiable) tile rasterization may be utilized according to the operation flow. The loss function may be generated based on a difference between the inferred 2D image and a ground truth (GT). A plurality of 2D images utilized for initialization of the 3D Gaussians may be utilized as the GT. The training unit may update the parameters constituting the 3D Gaussian in a direction to reduce the loss function.

The training unit adaptively adjusts a density of the 3D Gaussian by utilizing the density controller 108. The density controller 108 removes, copies, or splits the 3D Gaussian based on a size of the gradient or a size of the 3D Gaussian. The density controller 108 may efficiently represent the 3D space by adaptively adjusting the density of the 3D Gaussian.

The GS apparatus may include at least one memory in which a program for performing the above-described operations is stored, and at least one processor that executes the stored program.

Hereinafter, the dynamic GS apparatus according to the present disclosure will be described. With respect to the dynamic GS apparatus, a canonical 3D Gaussian set represents a set of canonical Gaussians that are representative of the entire time series of dynamic Gaussians. For example, when a time index is a reference time index (e.g., time index 0), the corresponding 3D Gaussian may be represented as a canonical 3D Gaussian. When a canonical Gaussian is defined for each of multiple time indices, the following described contents result in increased scalability, i.e., complexity. Accordingly, for convenience, the canonical 3D Gaussian is assumed to be a 3D Gaussian corresponding to one time (or time index). Hereinafter, a time series of the dynamic 3D Gaussians may be represented using time indices in addition to the canonical 3D Gaussian.

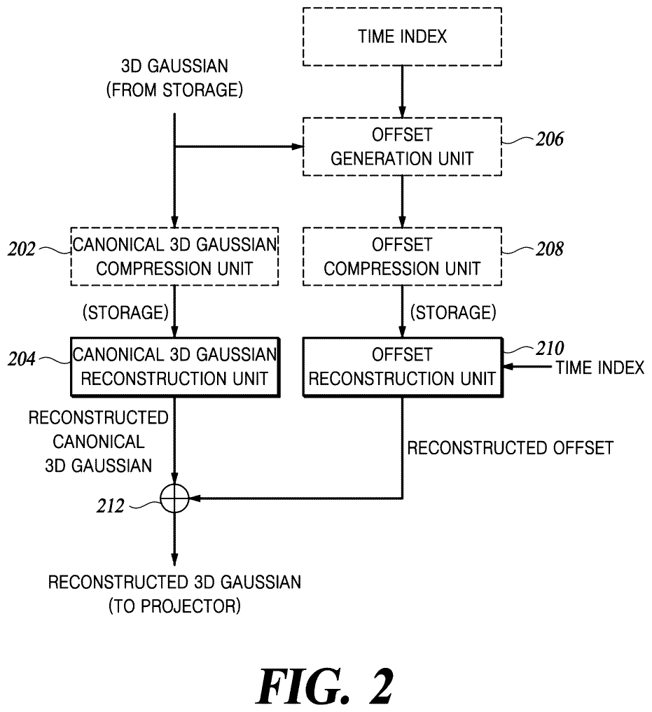

FIG. 2 is an exemplary diagram illustrating a dynamic Gaussian splatting apparatus according to an embodiment of the present disclosure.

The dynamic GS apparatus codes canonical 3D Gaussians and parameters representing time-indexed offsets by performing grouping for the canonical 3D Gaussians and offsets based on a codebook. In addition, the dynamic GS apparatus generates a reconstructed 3D Gaussian based on the reconstructed canonical 3D Gaussian and the offsets for each time index, and infers a 2D image corresponding to any time and view based on the reconstructed 3D Gaussian.

In addition to the components illustrated in FIG. 1, the dynamic GS apparatus further includes a canonical 3D Gaussian compression unit 202 (hereinafter, used interchangeably with a ‘Gaussian compression unit’, a canonical 3D Gaussian reconstruction unit 204 (hereinafter used interchangeably with a ‘Gaussian reconstruction unit’, an offset generation unit 206, an offset compression unit 208, an offset reconstruction unit 210, and an adder 212. As illustrated in FIG. 2, components added to the dynamic GS apparatus exist between the storage 102 and the projector 104. The codebook generated by the canonical 3D Gaussian compression unit 202 and the offset compression unit 210, the compressed Gaussian, and the compressed offset may be stored in the storage 102.

The components added in the illustration of FIG. 2 may all be used in training. In the inference process, the canonical 3D Gaussian reconstruction unit 204, the offset reconstruction unit 210, and the adder 212 may be used. With regard to the operation of the dynamic GS apparatus, operations of the remaining components illustrated in FIG. 1, in addition to the components added in FIG. 2, are the same, and thus a detailed description of the remaining components is omitted.

The canonical 3D Gaussians are initialized by a 3D point cloud obtained from a plurality of 2D images in a reference time index using a structure from motion (SfM) algorithm. Parameters constituting the canonical 3D Gaussians include location x, size s, rotation r, color c, and opacity o of the 3D Gaussian.

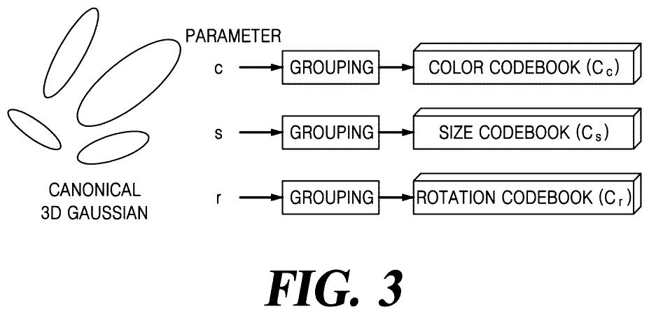

FIG. 3 is an exemplary diagram illustrating compression of a canonical 3D Gaussian according to an embodiment of the present disclosure.

The Gaussian compression unit 202 transforms, e.g., compresses, the canonical 3D Gaussian into a small number of representation elements using the codebook. Here, canonical 3D Gaussians stored in the storage 102 may be used. The Gaussian compression unit 202 generates the codebook based on grouping, and codes the canonical 3D Gaussian based on the generated codebook. Techniques such as vector quantization, etc., may be utilized for grouping of the parameters of the 3D Gaussian.

The vector quantization groups vectors composed of components of each parameter in a multi-dimensional space, and uses a vector representing each group. Using the vector quantization, a large-size vector input composed of continuous components may be represented by a small-size group index (hereinafter, used interchangeably with a code index). In vector dequantization, a representative value of vectors included in the group may be used as a reconstruction value. A mean value of the vectors included in the group may be used as a group representative value. Alternatively, a weighted mean value of vectors reflecting an influence of each vector may be used as the group representative value. In this case, the codebook represents a lookup table including a group representative value corresponding to a group index.

Among the parameters used for the 3D GS, a target of grouping (vector quantization) may be mean, covariance, spherical harmonics coefficient, and opacity, which are attributes of the 3D Gaussian splatting. Here, the mean is represented by the location x, and the covariance may be represented based on the rotation r and the size s according to a transformation process. A weighted sum of the spherical harmonics coefficients represents the color c of the 3D Gaussian. As an example, it is known that the number of 3D Gaussians used for the 3D GS is in a range of 106, and the number of parameters for one 3D Gaussian is 59. That is, it can be seen that when the 3D Gaussian is stored as it is, a large amount of GPU memory is required.

As an example, as in the example of FIG. 3, the Gaussian compression unit 202 may generate the codebook by grouping the color c, size s, and rotation r parameters of the canonical 3D Gaussian. The Gaussian compression unit 202 obtains the group index of a nearest code with respect to the canonical 3D Gaussian and uses the group index as vector quantized information of the canonical 3D Gaussian. For reconstruction of the canonical 3D Gaussian, the codebook and a code index are stored in the storage 102. Instead of storing all the parameters of the canonical 3D Gaussian, a codebook according to grouping and a code index representing the canonical 3D Gaussian are stored, so that the requirement of the GPU memory may be greatly reduced.

In the reconstruction, the Gaussian reconstruction unit 204 obtains the group representative value from the codebook by using the group index, and then uses the group representative value as reconstruction information for the color c, size s, and rotation r parameters of the standard 3D Gaussian.

In vector quantization based on the codebook, in order to determine a group in which a parameter vector is included, the Gaussian compression unit 202 may select a closest group by using a distance (e.g., L2-norm) between an input vector and a vector representing the group. In this case, the input vector is composed of continuous values. As another example, a weighted distance that reflects the sensitivity of each vector in addition to the distance between the vectors may be utilized.

Here, the sensitivity is based on a gradient of a sum of RGB values of all pixels in an image with respect to a gradient of each parameter vector. The Gaussian compression unit 202 may calculate a mean value (per pixel) of the gradient for all images constituting the data set as in Equation 1, and use the calculated mean value as the sensitivity of the parameter vector.

$$S ( p ) = \frac{1}{{\sum }_{i = 1}^{N} {P}_{i}} {\sum }_{i = 1}^{N} \vert \frac{\partial {E}_{i}}{\partial p} \vert \qquad [ Equation 1 ]$$

In Equation 1, Ei represents the sum of the RGB values of all pixels in the i-th image, and p represents a parameter offset vector. Pᵢ represents the number of pixels of the i-th image, and N represents the number of images.

As another example, the sensitivity representative of the vector may be calculated as follows. The Gaussian compression unit 202 calculates sensitivities for scalar values constituting each parameter vector, respectively. The Gaussian compression unit 202 may use a largest value as the sensitivity of the corresponding parameter vector, as shown in Equation 2.

$$S ( x ) = {max}_{d ∈ [ 1 … D ]} S ( {x}_{d} ) \qquad [ Equation 2 ]$$

In Equation 2, S(xd) represents the sensitivity of each parameter vector to scalar values, D represents a dimension of the parameter vector, and S(x) represents a sensitivity of the parameter vector.

After calculating the sensitivity of the parameter vector, the Gaussian compression unit 202 constructs a codebook by performing k-means grouping for each parameter based on K grouping centroids (where K is a natural number). In this case, an L2-norm between each grouping centroid vector and parameter may be used as the distance between the vectors (the input parameter vector and the centroid vector). Unlike this, as shown in Equation 3, a weighted distance obtained by multiplying the L2-norm by the sensitivity of the corresponding parameter may be used as the distance between the vectors.

$$D ( x , {c}_{k} ) = S ( x ) {‖ x - {c}_{k} ‖}_{2}^{2} \qquad [ Equation 3 ]$$

In Equation 3,

$${‖ \cdot ‖}_{2}^{2}$$

represents L2-norm, S(x) represents the sensitivity of the parameter vector, and Ck represents a k-th grouping centroid vector.

The Gaussian compression unit 202 performs grouping based on a distance between vectors calculated according to the above-described process. Each grouping centroid vector may be used as a representative value of vectors included in the group.

The Gaussian compression unit 202 may calculate a mean value of parameters in the group as a grouping centroid vector. Unlike this, as shown in Equation 4, a weighted mean value considering the sensitivity of the parameters in the group may be calculated as the grouping centroid vector.

$${c}_{k} = \frac{1}{{\sum }_{{x}_{i} ∈ A ( k )} S ( {x}_{i} )} {\sum }_{{x}_{i} ∈ A ( k )} S ( {x}_{i} ) {x}_{i} \qquad [ Equation 4 ]$$

In Equation 4, A(k) represents a k-th group, and xᵢ represents a vector included in the group.

As shown in Equation 1, the sensitivity is a value corresponding to a gradient of the sum of the RGB values of all pixels in the image with respect to the gradient of each parameter vector. That is, a highly sensitive parameter may have a greater influence on a reconstructed image.

When the sensitivity exceeds a specific threshold in the parameter grouping process, the Gaussian compression unit 202 excludes the grouping of the parameter vector, thereby preventing quality degradation of a rendered reconstructed image due to the grouping.

As an example, sensitivity-aware grouping may be performed on spherical harmonics coefficients corresponding to a color among 3D Gaussian parameters. In general, since the spherical harmonics coefficient has a value of 48 dimensions in the 3D GS, the Gaussian compression unit 202 may configure the 48-dimensional spherical harmonics coefficients in a single vector form and perform grouping for a plurality of vectors, thereby constructing the codebook. The number of vectors having a high sensitivity value among the plurality of spherical harmonics coefficient vectors may be relatively small. In this case, when the sensitivity is a spherical harmonics coefficient vector higher than a specific threshold, the Gaussian compression unit 202 excludes grouping of the corresponding vector, thereby preventing quality degradation of the rendered reconstructed image caused by the grouping.

In order to minimize deterioration in rendering quality due to the grouping of the spherical harmonics coefficient vectors higher than the specific threshold, the Gaussian compression unit 202 may perform clustering for spherical harmonics coefficients having a sensitivity lower than the specific threshold to generate the codebook.

As described above, a parameter vector to be grouped may be a parameter vector representing a mean, a covariance, or an opacity included in an attribute of the 3D GS in addition to the spherical harmonics coefficient.

As described above, covariance information may be divided and represented into an R vector indicating a rotation degree and an [symbol] vector indicating a size. For example, the covariance information may be decomposed into a size component and a rotation component using an eigenvalue decomposition. In this case, the R vector may be represented by four components, and the [symbol] vector may be represented by three components.

The size vector [symbol] representing x, y, and z axial direction sizes may be represented by normalizing the respective coefficients to an absolute size of the [symbol] vector. By transforming various size vectors into a normalized size vector form, grouping performance may be enhanced. As an example, when using the size vector [symbol] representing the size of the x, y, and z axes, the size vector [symbol] may be normalized by dividing the size vector [symbol] by the absolute size of the [symbol] vector. The absolute size of the [symbol] vector may be calculated as an L2-norm of the [symbol] vector.

As an example, in order to reduce the size of the codebook, the Gaussian compression unit 202 may quantize each code (corresponding to the above-described group representative value) in the codebook. For example, when 32 bits are required to represent each code in a floating-point scheme, each code may be represented by 8 bits using quantization. In quantization, a dynamic range of each code may be considered. For example, each code may be quantized by considering ranges of a minimum value and a maximum value of each code. When each code is quantized based on 8 bits, the minimum value and the maximum value may be divided into 256 intervals, and each code may be quantized based on the divided intervals. 256 intervals may be determined by dividing a gap between the minimum value and the maximum value into the same size, or each interval may be divided so as to have the same mass by considering a distribution of codes in the interval. In this case, a representative value of each interval may be determined as a center of mass. Quantization intervals of each code may be determined based on training. A quantization-aware training scheme may be utilized to train the quantization interval. The quantization aware training scheme may represent a method for performing quantization in a forward operation of a model, but bypassing the quantization process in a backward operation for gradient calculation.

As another example, the Gaussian compression unit 202 may further perform entropy coding to further reduce the size of the canonical 3D Gaussian information composed of the code index. Parameter-specific distribution information may be used to perform the entropy coding. The entropy coding is performed based on each parameter-specific distribution information, and as a result, the code indices may be transformed into a bitstream having a smaller size. Later, the bitstream having the smaller size may be inversely transformed into code indices by entropy decoding based on the same parameter-specific distribution information. Various schemes such as Huffman coding, arithmetic coding, run-length coding, LZ77 coding, and the like in the related art may be utilized as the entropy coding.

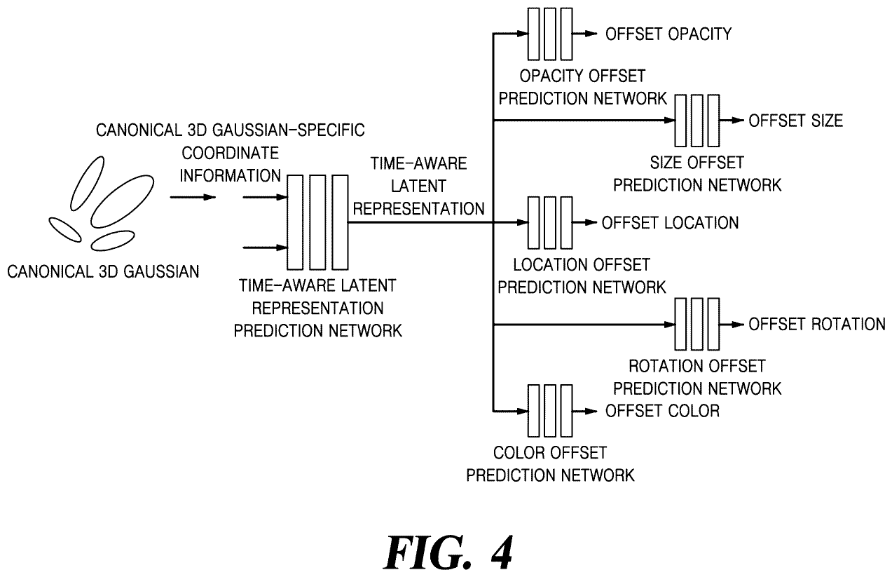

FIG. 4 is an exemplary diagram illustrating a process of generating parameter offsets according to an embodiment of the present disclosure.

The offset generation unit 206 obtains time indices as inputs. The offset generation unit 206 generates a difference of each parameter in each time index with respect to the parameters of the canonical 3D Gaussian, that is, a parameter offset. In this case, canonical 3D Gaussians stored in the storage 102 may be used. The parameter offset information is delivered to an offset compression unit 206.

In general, it is known that the number of time indices at which the parameter offset information is calculated is several hundreds.

As in the example of FIG. 4, the offset generation unit 206 may generate a time index-specific offset corresponding to a difference of each parameter by using one or more neural networks.

As an example, the offset generation unit 206 may obtain a time-aware latent representation by using a time-aware latent representation prediction network in which location and time information of the canonical 3D Gaussian are input, and then input the time-aware latent representation into a parameter-specific offset prediction network. The parameter-specific offset prediction network may output a time index-specific/parameter-specific offset.

In the example of FIG. 4, both the time-aware latent representation prediction network and the parameter-specific offset prediction network may be trainable neural networks (e.g., a multi-layer perceptron (MLP)). For each canonical Gaussian, the time index-specific parameter offset may include offsets such as offset transparency δₒ, an offset size δₛ, an offset location δₓ, an offset rotation δᵣ, an offset color δ_{c}, and the like.

As another example, the time-aware latent representation prediction network and the parameter-specific offset prediction network may be implemented using one prediction network. As another example, the parameter-specific offset prediction networks may be implemented using one prediction network.

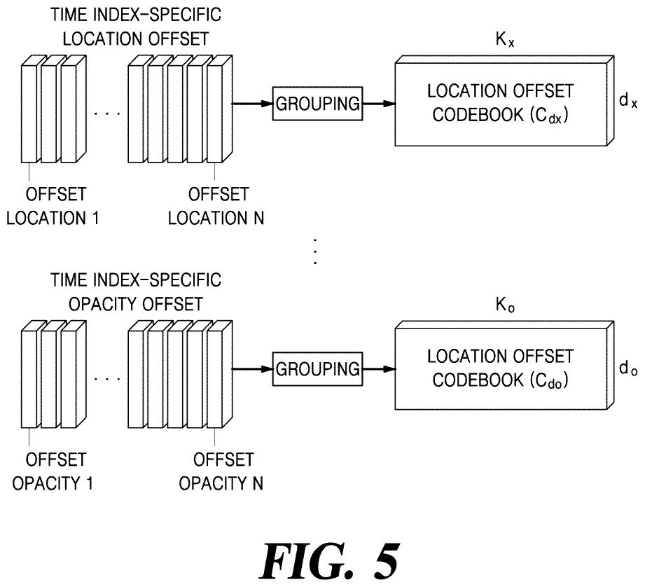

FIG. 5 is an exemplary diagram illustrating a compression process of the parameter offsets according to an embodiment of the present disclosure.

The offset compression unit 208 constructs a codebook C∈R^{K×d}. by performing grouping for a time index-specific offset with respect to each parameter. The offset compression unit 208 obtains an index of a nearest code and utilizes the obtained index as grouping information (that is, a coding index or a grouping index). In the example of FIG. 5, K corresponds to a size of a codebook (e.g., a size of a location offset codebook is Kₓ), and d corresponds to a dimension of each parameter component (e.g., for example, a dimension of the location offset codebook is dₓ). N represents the number of time indices.

The codebook may be constructed by individually performing grouping for location, rotation, size, color, and opacity offsets that constitute all offsets. Unlike this, a codebook for all offset bundles may be constructed. Alternatively, some offsets among the offsets may be connected by a bundle vector, and a codebook for the bundle vector may be generated. As an example, the rotation information and the size information may be connected to be constructed in one vector form indicating covariance information, and a codebook for a bundle vector indicating covariance information may be constructed. In the example of FIG. 5, the codebook is constructed in each offset by individually performing grouping for location, rotation, size, color, and opacity offsets.

For reconstruction of the offset, the codebook and the code index are stored in the storage 102. Here, the code index may be allocated to a time index-specific 3D Gaussian. Instead of storing all parameter offsets, a codebook according to grouping and a code index representing a parameter offset of the time index-specific 3D Gaussian are stored, so that the requirement of the GPU memory may be greatly reduced.

In the reconstruction, the offset reconstruction unit 210 reconstructs a nearest code (corresponding to a “grouping representative value”) from the codebook using the code index, and then uses the nearest code as reconstruction information for the parameter offset of the time index-specific 3D Gaussian.

The offset compression unit 208 constructs the offset with a smaller number of representation elements by using the grouping of the parameter offsets. The offset compression unit 208 generates the codebook by applying the grouping to the parameter offset, and codes the parameter offset based on the generated codebook. Techniques such as vector quantization, etc., may be utilized for grouping the parameter offsets.

The vector quantization groups vectors composed of components of each parameter offset on a multi-dimensional space, and uses a vector representing each group. Using the vector quantization, a large-size vector input composed of continuous components may be represented by a small-size group index (hereinafter, used interchangeably with a code index). In vector dequantization, a representative value of vectors included in the group may be used as a reconstruction value. A mean value of the vectors included in the group may be used as a group representative value. Alternatively, a weighted mean value of vectors reflecting an influence of each vector may be used as the group representative value. In this case, the codebook represents a lookup table including a group representative value corresponding to a group index.

Objects to be grouped (vector-quantized) among the parameter offsets may be a mean, a covariance, a spherical harmonics coefficient, and an opacity which are attributes of 3D Gaussian splatting. That is, an object to be grouped may be parameter-specific difference information between the canonical 3D Gaussian and a 3D Gaussian corresponding to a time index. Here, the mean is represented by the location x, and the covariance may be represented using the rotation r and the size s according to a transformation process. A weighted sum of the spherical harmonics coefficients represents the color c of the 3D Gaussian.

In vector quantization for the parameter offset based on the codebook, in order to determine a group in which a parameter vector is included, the offset compression unit 208 may select a nearest group by using a distance between an input parameter offset vector and a vector representing the group. In this case, the input parameter offset vector is composed of continuous values. As another example, a weighted distance that reflects the sensitivity of each parameter offset vector may be utilized in addition to the distance between the parameter offset vectors.

Here, the sensitivity is based on a gradient of a sum of RGB values of all pixels in an image with respect to a gradient of each parameter offset vector. The offset compression unit 208 may calculate a gradient mean value for all images constituting a data set as in Equation 5, and use the calculated mean value as the sensitivity of the parameter offset vector.

$$S ( p ) = \frac{1}{{\sum }_{i = 1}^{N} {P}_{i}} {\sum }_{i = 1}^{N} \vert \frac{\partial {E}_{i}}{\partial p} \vert \qquad [ Equation 5 ]$$

In Equation 5, Eᵢ represents the sum of the RGB values of all pixels in the i-th

image, and p represents a parameter offset vector. Pᵢ represents the number of pixels of the i-th image, and N represents the number of images.

As another example, the sensitivity representative of the parameter offset vector may be calculated as follows. The offset compression unit 208 calculates sensitivities for scalar values constituting each parameter vector, respectively. The offset compression unit 208 may use a largest value as the sensitivity of the corresponding parameter vector, as shown in Equation 6.

$$S ( x ) = {max}_{d ∈ [ 1 … D ]} S ( {x}_{d} ) \qquad [ Equation 6 ]$$

In Equation 6, S(x_{d}) represents the sensitivity of each parameter offset vector

to scalar values, D represents a dimension of the parameter offset vector, and S(x) represents a sensitivity of the parameter offset vector.

After calculating the sensitivity of the parameter offset vector, the offset compression unit 208 constructs the codebook by performing k-means grouping for each parameter offset based on K (where K is a natural number) grouping centroids. In this case, an L2-norm between a grouping centroid vector of each parameter offset and the parameter offset vector may be used as the distance between the vectors (the input parameter offset vector and the grouping centroid vector). Unlike this, as shown in Equation 7, a weighted distance obtained by multiplying the L2-norm by the sensitivity of the corresponding parameter offset may be used as the distance between the vectors.

$$D ( x , {c}_{k} ) = S ( x ) {‖ x - {c}_{k} ‖}_{2}^{2} \qquad [ Equation 7 ]$$

In Equation 7,

$${‖ \cdot ‖}_{2}^{2}$$

represents L2-norm, S(x) represents the sensitivity of the parameter offset vector, and Cₖ represents a k-th grouping centroid vector.

The offset compression unit 208 performs grouping based on a distance between vectors calculated according to the above-described process. Each grouping centroid vector of each parameter offset may be used as a representative value of parameter offset vectors included in the group.

The offset compression unit 208 may calculate a mean value of parameter offsets in the group as a grouping centroid vector of the parameter offset. Unlike this, as shown in Equation 8, a weighted mean value considering the sensitivity of the parameter offsets in the group may be calculated as the grouping centroid vector.

$${c}_{k} = \frac{1}{{\sum }_{{x}_{i} ∈ A ( k )} S ( {x}_{i} )} {\sum }_{{x}_{i} ∈ A ( k )} S ( {x}_{i} ) {x}_{i} \qquad [ Equation 8 ]$$

In Equation 8, A(k) represents a k-th group, and xi represents a vector included in the group.

The Gaussian reconstruction unit 204 obtains the group representative value from the codebook by using the code index, and then uses the group representative value as reconstruction information for the location x, color c, size s, rotation r, and opacity o parameters of the canonical 3D Gaussian, as described above.

The offset reconstruction unit 210 reconstructs the group representative value from the codebook by using the code index, and then uses the group representative value as reconstruction information for parameter offsets (an offset location δₓ, an offset color δ_{c}, an offset size δₛ, an offset rotation δᵣ, and an offset opacity δₒ) of the time index-specific 3D Gaussian, as described above.

The adder 212 adds the canonical 3D Gaussian and the parameter offset to reconstruct the time index-specific 3D Gaussian. The reconstructed time index-specific 3D Gaussian is delivered to the 2D image generation unit. As described above, the 2D image generation unit includes the projector 104 and the tile rasterizer 106. The dynamic GS apparatus may generate a time index-specific 2D image by performing rendering based on the reconstructed time index-specific 3D Gaussians.

As an example, the offset compression unit 208 may further perform entropy coding to further reduce the size of the parameter offset composed of the code index. Parameter offset-specific distribution information may be used to perform the entropy coding. The entropy coding is performed based on the parameter offset-specific distribution information, and as a result, the code indices may be transformed into a bitstream having a smaller size. Later, the bitstream having the smaller size may be inversely transformed into code indices by entropy decoding based on the same parameter offset-specific distribution information. Various schemes such as Huffman coding, arithmetic coding, run-length coding, LZ77 coding, and the like in the related art may be utilized as the entropy coding.

As an example, the offset compression unit 208 may perform compression of the parameter offset for only some Gaussians. When there is no difference between attribute values of Gaussians previously reconstructed in a previous time index t-1 and Gaussians reconstructed in a current time index t, or when the difference is less than a preset threshold, the reconstructed Gaussians of the previous time index t-1 may be used as the reconstructed Gaussians of the current time index t. That is, when there is no difference between the parameter offset generated in the previous time index t-1 and a parameter offset generated in the current time index t, or when the difference is less than a preset threshold, the reconstructed Gaussians of the previous time index t-1 may be used as the reconstructed Gaussians of the current time index t. In the above-described case, the offset compression unit 208 may omit compression of the parameter offset for the current time index t. The dynamic GS apparatus according to the present disclosure may achieve high compression efficiency for dynamic Gaussians with low motion, and shorten the reconstruction process.

As an example, based on a comparison of the parameter offsets, the offset compression unit 208 may omit compressing the parameter offsets for all Gaussians included in each time index. Alternatively, the offset compression unit 208 may perform compression of the parameter offset for spatially subdivided Gaussians. As an example, based on the comparison of the time-index-specific parameter offsets, whether to compress the parameter offsets with respect to all Gaussians may be determined. Whether compression is performed for each time index may be represented by 1-bit information (hereinafter, referred to as “offset compression information”). As another example, all time index-specific Gaussians may be spatially divided, and whether the parameter offset is compressed may be determined in each divided region. Whether the time index and divided region-specific parameter offsets are compressed may be represented by 1-bit information. For example, when an entire space is bi-divided by the x, y, and z axes and there are eight divided regions for each time index, whether the divided region for each time index is compressed may be represented by 8 bits. The spatial division described above may vary depending on an application, in addition to bi-dividing. As another example, whether the parameter offsets for each time index are compressed may be determined for each Gaussian.

The above-described comparison of parameter offsets for each time index may be performed in various steps. As an example, after the offset is generated, the offset compression unit 208 may calculate a difference for each time index based on the generated offset to determine whether to compress the offset. Alternatively, after reconstructing the offset, the offset compression unit 208 may calculate the difference for each time index based on the reconstructed offset to determine whether the offset is compressed.

As described above, the offset compression information indicating whether the offset is compressed for each time index or for each time index and divided region is represented by 1-bit information, but the offset compression unit 208 may further perform entropy coding for the offset compression Information. Binary distribution information of the offset compression information may be used to perform the entropy coding. The entropy coding is performed based on the binary distribution information of the offset compression information, and as a result, the offset compression information may be transformed into a bitstream having a smaller size than 1 bit on average. Later, the bitstream having the smaller size may be inversely transformed as offset compression information by entropy decoding based on the binary distribution information for the offset compression information.

In the above-described example, it is described to determine whether the offset of the current time index t is compressed with respect to the parameter offsets of the previous time index t-1 and the current time index t. However, a reference time index to be compared with the current time index t may vary in addition to t-1. As an example, after comparing offsets of a plurality of time indices t-4, t-3, t-2, and t-1, the offset compression unit 208 may designate a reference time index that may omit compressing the offset of the current time index t, and include the designated reference time index as the offset compression information.

The offset compression unit 208 may further perform the entropy coding for the above-described reference time index. In order to perform the entropy coding, distribution information of the reference time index may be used. The entropy coding is performed based on the distribution information of the reference time index, and as a result, the reference time index may be transformed into a bitstream having a smaller size. As an example, when the reference time indices of t-4, t-3, t-2, and t-1 described above are used, since a probability that the time index of t-1 is the reference time index may be relatively high, according to the entropy coding, the reference time index may be represented by a bitstream having a smaller size than 2 bits on average. Later, the bitstream having the smaller size may be inversely transformed as the offset compression information by entropy decoding based on the distribution information of the reference time index.

As described above, the components added in the illustration of FIG. 2 may all be used for training.

For example, the training unit generates a codebook based on the grouping of the canonical 3D Gaussian, and codes the canonical 3D Gaussian based on the generated codebook. As described above, the training unit may utilize vector quantization for grouping parameters of a 3D Gaussian. The training unit stores a codebook and a code index of the canonical 3D Gaussian generated according to grouping and coding in the storage 102.

The training unit inputs the time index and the location of the canonical 3D Gaussian into a prediction network to generate an offset for each time index/parameter.

The training unit generates a codebook based on grouping of parameter offsets, and codes the parameter offsets based on the generated codebook. As described above, the training unit may utilize vector quantization for the grouping of the parameter offsets. The training unit stores a codebook and a code index of the parameter offset generated according to grouping and coding in the storage 102. Here, the code index may be allocated to a time index-specific 3D Gaussian.

The training unit reconstructs a group representative value from the codebook by using the code index of the canonical 3D Gaussian, and uses the reconstructed group representative value as the canonical 3D Gaussian. The training unit reconstructs the group representative value from the codebook by using a code index of the offset of the parameter, and uses the reconstructed group representative value as a parameter offset of the time index-specific 3D Gaussian. The training unit adds the canonical 3D Gaussian and the parameter offset to reconstruct the time index-specific 3D Gaussian. The reconstructed time index-specific 3D Gaussian is delivered to the 2D image generation unit.

The gradient flow illustrated in FIG. 1 may be additionally utilized for training of the canonical 3D Gaussian and the prediction network. The training unit infers a 2D image based on a camera pose and reconstructed 3D Gaussians utilized for initialization of the canonical 3D Gaussians. Here, projection and (differentiable) tile rasterization may be utilized according to an operation flow. A loss function may be generated based on a difference between the inferred 2D image and a ground truth (GT). A plurality of 2D images utilized for the initialization of the canonical 3D Gaussians, and 2D images corresponding to the time index may be utilized as the GT. For example, the training unit may update parameters constituting the canonical 3D Gaussian in a direction to reduce the loss function. Further, the training unit may update the parameters of the prediction network illustrated in FIG. 4, in the direction to reduce the loss function.

Additionally, the training unit adaptively adjusts a density of the canonical 3D Gaussian by utilizing the density controller 108.

Thereafter, repeated processes may be performed. The training unit performs grouping/coding for the updated canonical 3D Gaussian to update the codebook and the code index of the canonical 3D Gaussian.

The training unit may generate an offset for each time index/parameter based on the updated prediction network, and perform grouping/coding for the generated parameter offset to update the codebook and the code index of the parameter offset.

With respect to vector quantization of the canonical 3D Gaussians or the parameter offset, the coding process takes a lot of time to search the codebook to determine the code index. In general, the coding process is known to be a more complex process than the grouping process. Therefore, the training unit may perform grouping for each iteration of training, and may perform coding for every predetermined period (e.g., hundreds of iterations).

As described above, in inference, the dynamic GS apparatus may use the canonical 3D Gaussian reconstruction unit 204, the offset reconstruction unit 210, and the adder 212. In the inference, the codebook and the code index of the canonical 3D Gaussian stored in the storage unit 102 and the codebook and the code index of the parameter offset are utilized. As inputs, a camera pose indicating a time index and any view is used. As illustrated in FIG. 2, a time index input into the offset generation unit 206 is used in a training process, and a time index input into the offset reconstruction unit 210 is used in an inference process.

The time index may be limited to one of the time indices used in the training process. By limiting the time index, use of the prediction network may be excluded in the inference, and the storage 102 may omit a process of storing parameters of the prediction network and coding parameter offsets.

The dynamic GS apparatus reconstructs the group representative value from the codebook by using the code index, and uses the reconstructed group representative value as the canonical 3D Gaussian. The dynamic GS apparatus reconstructs a nearest code from the codebook of the parameter offset by using the code index corresponding to the time index, and uses the reconstructed nearest code as the parameter offset corresponding to the time index. The dynamic GS apparatus adds the canonical 3D Gaussian and the parameter offset to reconstruct a 3D Gaussian corresponding to the time index. The reconstructed 3D Gaussian corresponding to the time index is delivered to the projector 104, as illustrated in FIG. 2.

The operation flow illustrated in FIG. 1 may be additionally utilized for generating the 2D image based on the reconstructed 3D Gaussian corresponding to the time index. The dynamic GS apparatus infers a time index and a 2D image at any view based on the camera pose and the reconstructed 3D Gaussians. In this case, the projection and the (differentiable) tile rasterization may be utilized.

The dynamic GS apparatus may include at least one memory in which a program for performing the above-described operation and an operation to be described below is stored, and at least one processor that executes the stored program.

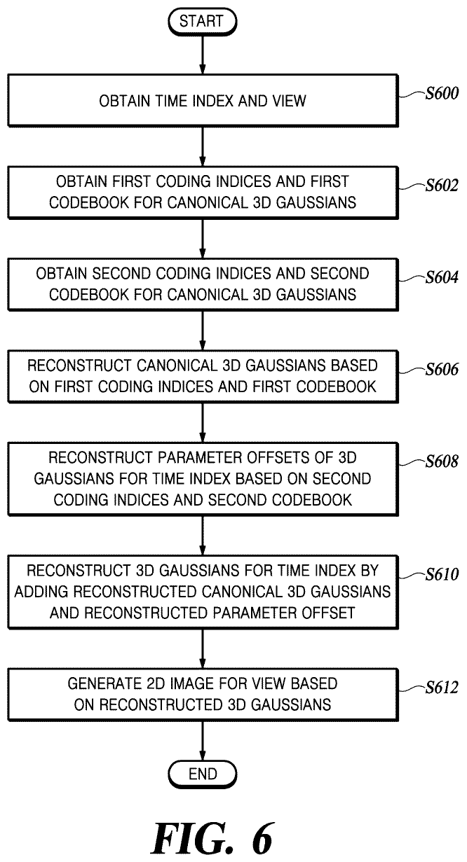

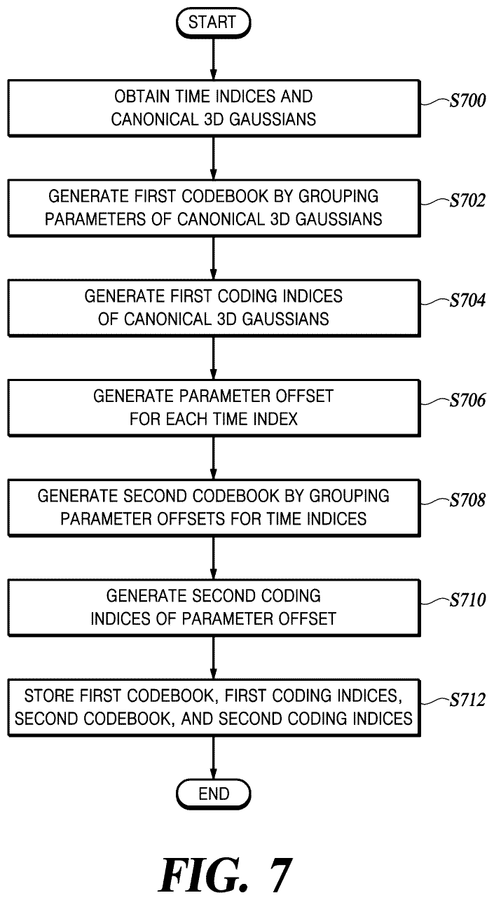

Hereinafter, a method for compressing a dynamic 3D space and a method for generating a 2D image by a dynamic GS apparatus will be described with reference to illustrations of FIGS. 6 and 7.

FIG. 6 is a flowchart illustrating a method for generating a 2D image by a dynamic Gaussian splatting apparatus according to an embodiment of the present disclosure.

The dynamic GS apparatus obtains a time index and a view (S600).

The dynamic GS apparatus obtains a desired time index and a desired view for a user. The desired view corresponds to a camera pose desired by the user.

The dynamic GS apparatus obtains first coding indices and a first codebook for canonical 3D Gaussians (S602). Here, the canonical 3D Gaussians are 3D Gaussians corresponding to a reference time index, and represent a 3D space corresponding to the reference time index.

As an example, the dynamic GS apparatus may obtain the first coding indices and the first codebook from the storage 102. As another example, when a bitstream including information related to the dynamic GS apparatus is transmitted, the dynamic GS apparatus may obtain the first coding indices and the first codebook from the bitstream. Parameters of the canonical 3D Gaussians include a location, a rotation, a color, and an opacity.

The dynamic GS apparatus obtains second coding indices and a second codebook for a parameter offset (S604). Here, the parameter offset indicates difference information between the canonical 3D Gaussians and 3D Gaussians for the time index.

The dynamic GS apparatus may obtain the second coding indices and the second codebook from the storage 102. As another example, when the bitstream is transmitted, the dynamic GS apparatus may obtain the second coding indices and the second codebook from the bitstream. The parameter offset includes an offset location, an offset size, an offset rotation, an offset color, and an offset opacity.

The dynamic GS apparatus reconstructs the canonical 3D Gaussians based on the first coding indices and the first codebook (S606).

The dynamic GS apparatus reconstructs parameter offsets of the 3D Gaussians for the time index based on the second coding indices and the second codebook (S608).

The dynamic GS apparatus adds the reconstructed canonical 3D Gaussians and the reconstructed parameter offset to reconstruct the 3D Gaussians for the time index (S610).

As an example, the dynamic GS apparatus may obtain offset compression information indicating whether the parameter offset is compressed in a current time index. For example, the dynamic GS apparatus may obtain the offset compression information from the storage 102. According to a value of the offset compression information, the dynamic GS apparatus may determine whether the parameter offset is compressed in the current time index. When the compression of the parameter offset is omitted in the current time index, the dynamic GS apparatus may use 3D Gaussians generated in a previous time index as the 3D Gaussians of the current time index.

The dynamic GS apparatus generates a 2D image for a view based on the reconstructed 3D Gaussians (S612).

Meanwhile, the first coding indices, the first codebook, the second coding indices, and the second codebook may be generated in advance by a training unit that trains the dynamic GS apparatus to learn the generation of the 2D image.

FIG. 7 is a flowchart illustrating a method for compressing a dynamic 3D space by the dynamic Gaussian splatting apparatus according to an embodiment of the present disclosure.

For example, the dynamic GS apparatus may obtain a 3D point cloud from a plurality of 2D images constituting a 3D space in the reference time index using an SfM algorithm, and initialize the canonical 3D Gaussians based on the obtained 3D point cloud.

The dynamic GS apparatus obtains time indices and canonical 3D Gaussians (S700). Here, the canonical 3D Gaussians are 3D Gaussians corresponding to a reference time index, and represent a 3D space corresponding to the reference time index. Parameters of the canonical 3D Gaussians include a location, a rotation, a color, and an opacity.

The dynamic GS apparatus generates a first codebook by grouping the parameters of the canonical 3D Gaussians (S702).

The dynamic GS apparatus generates the first coding indices of the canonical 3D Gaussians based on a nearest code in the first codebook (S704).

The dynamic GS apparatus generates a parameter offset for each time index by using a deep learning based prediction network based on each time index and the locations of the canonical 3D Gaussians (S706). Here, the parameter offset indicates differences between the canonical 3D Gaussians and the 3D Gaussians for each time index. The parameter offset includes an offset location, an offset size, an offset rotation, an offset color, and an offset opacity.

The dynamic GS apparatus generates the second codebook by grouping parameter offsets for time indices (S708).

The dynamic GS apparatus generates the second coding indices of the parameter offsets for the 3D Gaussians based on a nearest code in the second codebook (S710).

The dynamic GS apparatus stores the first codebook, the first coding indices, the second codebook, and the second coding indices (S712).

As an example, when a difference between a parameter offset generated in a previous time index and a parameter offset generated in a current time index is less than a preset threshold, the dynamic GS apparatus may omit compression of the parameter offset of the current time index. The dynamic GS apparatus may set a value of offset compression information according to whether the parameter offset is compressed in the current time index, and store the offset compression information.

As an example, the dynamic GS apparatus may store the first codebook, the first coding indices, the second codebook, and the second coding indices in the storage 102. As another example, the dynamic GS apparatus may generate and transmit a bitstream including the first codebook, the first coding indices, the second codebook, and the second coding indices.

Then, the dynamic GS apparatus may infer a 2D image based on the stored first codebook, the stored first coding indices, the stored second codebook, and the stored second coding indices as follows according to the example of FIG. 6 described above.

The dynamic GS apparatus may obtain the first coding indices and the first codebook, and reconstruct the canonical 3D Gaussians based on the first coding indices and the first codebook. The dynamic GS apparatus may obtain the second coding indices and the second codebook, and reconstruct parameter offsets of 3D Gaussians for each time index based on the second coding indices and the second codebook. Here, the dynamic GS apparatus may obtain the first coding indices, the first codebook, the second coding indices, and the second codebook from the storage 102.

Meanwhile, the dynamic GS apparatus may obtain the offset compression information in the current time index from the storage 102. According to a value of the offset compression information, the dynamic GS apparatus may determine whether the parameter offset is compressed in the current time index. When the compression of the parameter offset is omitted in the current time index, the dynamic GS apparatus may use 3D Gaussians generated in a previous time index as the 3D Gaussians of the current time index.

The dynamic GS apparatus may obtain a view. The dynamic GS apparatus adds the reconstructed canonical 3D Gaussians and the reconstructed parameter offset to reconstruct the 3D Gaussians for each time index. The dynamic GS apparatus may infer a 2D image for the view based on the reconstructed 3D Gaussians.

As an example, the training unit in the dynamic GS apparatus may train the dynamic Gaussian splatting apparatus based on the inferred 2D image and ground truth (GT). Here, the GT includes a plurality of 2D images utilized for initialization of the canonical 3D Gaussians, and 2D images corresponding to the time indices. The training unit may calculate a loss function based on a difference between the inferred 2D image and the Ground truth (GT). The training unit may update parameters of the canonical 3D Gaussians in a direction to reduce the loss function, and update parameters of a prediction network.

The components described in the example embodiments may be implemented by hardware components including, for example, at least one digital signal processor (DSP), a processor, a controller, an application-specific integrated circuit (ASIC), a programmable logic element, such as an FPGA, other electronic devices, or combinations thereof. At least some of the functions or the processes described in the example embodiments may be implemented by software, and the software may be recorded on a recording medium. The components, the functions, and the processes described in the example embodiments may be implemented by a combination of hardware and software.

The method according to example embodiments may be embodied as a program that is executable by a computer, and may be implemented as various recording media such as a magnetic storage medium, an optical reading medium, and a digital storage medium.

Various techniques described herein may be implemented as digital electronic circuitry, or as computer hardware, firmware, software, or combinations thereof. The techniques may be implemented as a computer program product, i.e., a computer program tangibly embodied in an information carrier, e.g., in a machine-readable storage device (for example, a computer-readable medium) or in a propagated signal for processing by, or to control an operation of a data processing apparatus, e.g., a programmable processor, a computer, or multiple computers. A computer program(s) may be written in any form of a programming language, including compiled or interpreted languages and may be deployed in any form including a stand-alone program or a module, a component, a subroutine, or other units suitable for use in a computing environment. A computer program may be deployed to be executed on one computer or on multiple computers at one site or distributed across multiple sites and interconnected by a communication network.

Processors suitable for execution of a computer program include, by way of example, both general and special purpose microprocessors, and any one or more processors of any kind of digital computer. Generally, a processor will receive instructions and data from a read-only memory or a random access memory or both. Elements of a computer may include at least one processor to execute instructions and one or more memory devices to store instructions and data. Generally, a computer will also include or be coupled to receive data from, transfer data to, or perform both on one or more mass storage devices to store data, e.g., magnetic, magneto-optical disks, or optical disks. Examples of information carriers suitable for embodying computer program instructions and data include semiconductor memory devices, for example, magnetic media such as a hard disk, a floppy disk, and a magnetic tape, optical media such as a compact disk read only memory (CD-ROM), a digital video disk (DVD), etc. and magneto-optical media such as a floptical disk, and a read only memory (ROM), a random access memory (RAM), a flash memory, an erasable programmable ROM (EPROM), and an electrically erasable programmable ROM (EEPROM) and any other known computer readable medium. A processor and a memory may be supplemented by, or integrated into, a special purpose logic circuit.

The processor may run an operating system (OS) and one or more software applications that run on the OS. The processor device also may access, store, manipulate, process, and create data in response to execution of the software. For purpose of simplicity, the description of a processor device is used as singular; however, one skilled in the art will be appreciated that a processor device may include multiple processing elements and/or multiple types of processing elements. For example, a processor device may include multiple processors or a processor and a controller. In addition, different processing configurations are possible, such as parallel processors.

Also, non-transitory computer-readable media may be any available media that may be accessed by a computer, and may include both computer storage media and transmission media.

The present specification includes details of a number of specific implements, but it should be understood that the details do not limit any invention or what is claimable in the specification but rather describe features of the specific example embodiment. Features described in the specification in the context of individual example embodiments may be implemented as a combination in a single example embodiment. In contrast, various features described in the specification in the context of a single example embodiment may be implemented in multiple example embodiments individually or in an appropriate sub- combination. Furthermore, the features may operate in a specific combination and may be initially described as claimed in the combination, but one or more features may be excluded from the claimed combination in some cases, and the claimed combination may be changed into a sub-combination or a modification of a sub-combination.

Similarly, even though operations are described in a specific order on the drawings, it should not be understood as the operations needing to be performed in the specific order or in sequence to obtain desired results or as all the operations needing to be performed. In a specific case, multitasking and parallel processing may be advantageous. In addition, it should not be understood as requiring a separation of various apparatus components in the above described example embodiments in all example embodiments, and it should be understood that the above-described program components and apparatuses may be incorporated into a single software product or may be packaged in multiple software products.

It should be understood that the example embodiments disclosed herein are merely illustrative and are not intended to limit the scope of the invention. It will be apparent to one of ordinary skill in the art that various modifications of the example embodiments may be made without departing from the spirit and scope of the claims and their equivalents.

Accordingly, one of ordinary skill would understand that the scope of the claimed invention is not to be limited by the above explicitly described embodiments but by the claims and equivalents thereof.

What is claimed is:

1. A method for generating a 2-dimensional (2D) image, which is performed by a dynamic Gaussian splatting apparatus, the method comprising:
obtaining a time index and a view;
obtaining first coding indices and a first codebook for canonical 3D Gaussians, wherein the canonical 3D Gaussians are 3D Gaussians corresponding to a reference time index, and represent a 3D space corresponding to the reference time index;
obtaining second encoding indices and a second codebook for a parameter offset, wherein the parameter offset indicates a difference between the canonical 3D Gaussians and 3D Gaussians for the time index;
reconstructing the canonical 3D Gaussians based on the first coding indices and the first codebook;
reconstructing parameter offsets of the 3D Gaussians for the time index based on the second coding indices and the second codebook;
adding the reconstructed canonical 3D Gaussians and the reconstructed parameter offset to reconstruct the 3D Gaussians for the time index; and
generating a second image for the view based on the reconstructed 3D Gaussians.

2. The method of claim 1, wherein parameters of the canonical 3D Gaussians include a location, a size, a rotation, a color, and an opacity.

3. The method of claim 1, wherein the parameter offset includes an offset location, an offset size, an offset rotation, an offset color, and an offset opacity.

4. The method of claim 1, wherein the first coding indices, the first codebook, the second coding indices, and the second codebook are generated in advance based on training the dynamic Gaussian splatting apparatus.

5. The method of claim 1, further comprising:
obtaining offset compression information indicating whether the parameter offset is compressed in a current time index; and
determining whether the parameter offset is compressed in the current time index according to a value of the offset compression information, wherein, in reconstructing the canonical 3D Gaussians, when the compression of the parameter offset is omitted in the current time index, 3D Gaussians generated in a previous time index are used as the 3D Gaussians of the current time index.

6. A dynamic Gaussian splatting apparatus comprising:
a storage configured to store first coding indices and a first codebook for canonical 3D Gaussians, and second coding indices and a second codebook for a parameter offset, wherein the canonical 3D Gaussians are 3D Gaussians corresponding to a reference time index, and represent a 3D space corresponding to the reference time index, and the parameter offset indicates a difference between the canonical 3D Gaussians and 3D Gaussians for the time index;
a Gaussian reconstruction unit configured to reconstruct the canonical 3D Gaussians based on the first coding indices and the first codebook;
an offset reconstruction unit configured to obtain a time index, and reconstruct parameter offsets of the 3D Gaussians for the time index based on the second coding indices and the second codebook;
an adder configured to reconstruct the 3D Gaussians for the time index by adding the reconstructed canonical 3D Gaussians and the reconstructed parameter offset; and
a 2D image generation unit configured to obtain a view, and generate a 2D image for the view based on the reconstructed 3D Gaussians.

7. The dynamic Gaussian splatting apparatus of claim 6, wherein parameters of the canonical 3D Gaussians include a location, a size, a rotation, a color, and an opacity.

8. The dynamic Gaussian splatting apparatus of claim 6, wherein the parameter offset includes an offset location, an offset size, an offset rotation, an offset color, and an offset opacity.

9. The dynamic Gaussian splatting apparatus of claim 6, wherein the first coding indices, the first codebook, the second coding indices, and the second codebook are generated in advance by training the dynamic Gaussian splatting apparatus.

10. A method for compressing a dynamic 3-dimensional (3D) space, which is performed by a dynamic Gaussian splatting apparatus, the method comprising:
obtaining time indices and canonical 3D Gaussians, wherein the canonical 3D Gaussians are 3D Gaussians corresponding to a reference time index, and represent a 3D space corresponding to the reference time index;
generating a first codebook by grouping parameters of the canonical 3D Gaussians;
generating first coding indices of the canonical 3D Gaussians based on a nearest code in the first codebook;
generating a parameter offset for each time index by using a deep learning-based prediction network based on each time index and locations of the canonical 3D Gaussians, wherein the parameter offset indicates a difference between the canonical 3D Gaussians and 3D Gaussians for each time index;
generating a second codebook by grouping parameter offsets for time indices;
generating second coding indices of parameter offsets for the 3D Gaussians of the time indices based on a nearest code in the second codebook;
storing the first codebook, the first coding indices, the second codebook, and the second coding indices; and
inferring a 2D image based on the first codebook, the first coding indices, the second codebook, and the second coding indices.

11. The method of claim 10, further comprising:
omitting compression of the parameter offset of the current time index, when a difference between a parameter offset generated in a previous time index and a parameter offset generated in a current time index is less than a preset threshold;
setting a value of offset compression information according to whether the parameter offset is compressed in the current time index; and
storing the offset compression information.

12. The method of claim 11, wherein the process of inferring the 2D image comprises:
obtaining the first coding indices and the first codebook, and reconstructing the canonical 3D Gaussians based on the first coding indices and the first codebook.

13. The method of claim 12, wherein inferring the 2D image further comprises:
obtaining the second coding indices and the second codebook; and
reconstructing parameter offsets of 3D Gaussians for each time index based on the second coding indices and the second codebook.

14. The method of claim 13, wherein inferring the 2D image further comprises:
obtaining a view;
reconstructing the 3D Gaussians for each time index by adding the reconstructed canonical 3D Gaussians and the reconstructed parameter offset; and
generating a second image for the view based on the reconstructed 3D Gaussians.

15. The method of claim 10, further comprising:
training the dynamic Gaussian splatting apparatus based on the inferred 2D image and a ground truth (GT),
wherein the GT includes a plurality of 2D images used for initializing the canonical 3D Gaussians and 2D images corresponding to the time indices.

16. The method of claim 15, wherein training the dynamic Gaussian splatting apparatus further comprises:
calculating a loss function based on a difference between the inferred 2D image and the ground truth (GT);
updating parameters of the canonical 3D Gaussians in order to reduce the loss function; and
updating parameters of the prediction network in order to reduce the loss function.
